(19) United States
(12) Patent Application Publication
(10) Pub. No.: US 2026/0063506 A1
(43) Pub. Date: Mar. 5, 2026

(54) DEFLECTOMETRY METHOD AND ASSOCIATED SYSTEM

(71) Applicant: CENTRE NATIONAL DE LA RECHERCHE SCIENTIFIQUE, PARIS (FR)

(72) Inventors: Alexandre ARNOULT, TOULOUSE (FR); Bastien GRIMALDI, TOULOUSE (FR)

(21) Appl. No.: 19/100,510

(22) PCT Filed: Jul. 31, 2023
(86) PCT No.: PCT/EP2023/071132

§ 371 Date: Jan. 31, 2025

(30) Foreign Application Priority Data
Aug. 4, 2022 (FR) 2208107

(51) Int. Cl. G01M 11/00; G01B 11/25

(52) U.S. Cl. CPC G01M 11/005; G01B 11/2527

(57) ABSTRACT

A method is provided for analyzing a reflective surface through deflectometry, with a system including a display and imaging optics. The method includes the following steps: successively displaying n luminous images on the display, a luminous image having a binarized luminous intensity that is obtained by dithering the pattern M(x−xi), detecting, on the matrix detector, n images obtained by reflection of the n luminous images from the reflective surface, determining a function, referred to as object absolute phase function, based on the n detected images, the function g also satisfying the relationship: g(k·M)=g(M), with k being any real value, comparing the object absolute phase function with a reference absolute phase function, and deducing therefrom information about the shape of the surface.

### CROSS-REFERENCE TO RELATED APPLICATIONS

This application is a National Stage of International patent application PCT/EP2023/071132, filed on Jul. 31, 2023, which claims priority to foreign French patent application No. FR 2208107, filed on Aug. 4, 2022, the disclosures of which are incorporated by reference in their entireties.

### FIELD OF THE INVENTION

The present invention relates to the field of deflectometry for the analysis of the shape of a surface.

### BACKGROUND

The principle of phase-shifting deflectometry (PSD) for analyzing a surface S of an object Obj is known. A conventional assembly of a PSD device 5 is illustrated in FIG. 1. It comprises a display Disp0 configured to successively display 4 images I [symbol] 0i(x,y), i being an index varying from 1 to 4, the 4 images being a sinusoidal intensity pattern MS(x) along an axis X respectively shifted by 0, π/2, π, 3π/2. FIG. 2 illustrates, in A, the sinusoidal pattern MS(x) and, in B, the four intensity profiles, along x, of the images/patterns MSi(x), with MS1(x) corresponding to a phase of 0, MS2(x) corresponding to a phase of π/2, MS3(x) corresponding to a phase of a and MS4(x) corresponding to a phase of 3π/2. In the example of FIG. 2, the amplitude of 1 of the sinusoid is coded, in B, between 0 and 255 (8 bits). The reference frame (X,Y) is defined in the plane of the displayed image.

Considering that I [symbol] 0i(x,y) represents the intensity, between 0 and 1 (amplitude), of an image and (x,y) represents the horizontal and vertical pixel positions on the screen, it may be said for example that MSi(x)=I [symbol] 0i(x,0), because the pattern is variable only along x.

Thus, for all values of y, MSi(x)=I [symbol] 0i(x,y)=0.5·[cos((2π/Λ)·x+φi)+1]

where Λ is the spatial period in pixels on the screen of the sine (or cosine) and φi is the phase of the ith image and assumes for example the value 0, π/2, π, 3π/2.

The display Disp0 is arranged such that the displayed luminous images I [symbol] 0i are reflected from the surface S to be characterized (which locally has a normal N) of the object Obj. What is of interest here is specular reflection, and the reflection from the surface is oblique. The device also comprises imaging optics (not shown) and a matrix detector Det0, the imaging optics being configured to image the surface S on the detector Det0. The imaging optics and detector assembly is for example a camera, which sequentially takes 4 images Id0i corresponding to that part of the sinusoidal pattern MSi (displayed on Disp0) reflected by S, imaged, and detected by Det0. The 4 images Id0i are then processed by a processing unit (not shown), which, based on these 4 detected images, determines the properties of the surface of the object Obj, and more particularly its relief, in order typically to identify surface defects.

In a typical deflectometry configuration such as the one shown in FIG. 1, the camera has to be kept tilted relative to the part of the surface to be inspected in order to be able to image reflected light coming from the display. The display and the optical axis of the camera thus have to be positioned beyond a minimum angle with respect to the part of the surface to be inspected. Indeed, without adding an angle, the camera would block the light from the screen or vice versa. To recover all of the light, it is sufficient to reach the minimum angle from which visibility is total.

The angle of the ray reflected by the surface S depends on the local slope of the surface at the point of impact of the ray. (x,y) is the name given to the coordinates of the displayed images I [symbol] 0i(x,y) (reference frame X,Y), and (x′,y′) is the name given to the coordinates of the detected images Id0i(x′,y′); there is typically a magnification factor between the two systems.

The idea is that, when the surface S, at a point P (xₚ,yₚ), locally exhibits a local slope α_{P} (α_{xP}, α_{yP}) with respect to the planar reference surface, a fringe reflected by this surface S will be shifted on the detector by a shift dx′_{P} in the direction x and dy′_{P} in the direction y, these two quantities depending directly and respectively on the local slopes (α_{xP}, α_{yP}). Thus, knowing the geometrical parameters of the system, based on the shift dP(dx′_{P}, dy′_{P}), it is possible to deduce the local slope α_{P}(α_{xP}, α_{yP}) on the surface S at P. Based on these slopes α_{P}, differentiation is used to obtain the curvature of S at each point and integration is used to obtain the altitude of S at each point (distribution of heights).

Thus, in the processing, the 4 detected images Id0i are compared with 4 images Id0_{ref}i obtained by reflection of the images I [symbol] 0i from a planar reference surface Sref positioned in place of the object Obj.

The images Id0_{ref}i are non-distorted sinusoidal patterns similar to the displayed images, to within the magnification factor.

What is referred to as an object set, consisting of the 4 images Id0i, and what is referred to as a reference set, consisting of the 4 reference images Id0_{ref}i, are defined.

For the comparison, what is referred to as an absolute phase function is calculated for each of the two object and reference image sets, respectively called object absolute phase function fap0_{S} and reference absolute phase function fap0_{Ref}, by applying a mathematical function g0 to the 4 images corresponding to 4 variables that we will name for the formula f1, f2, f3 and f4, equal to:

$$g 0 = arc tg ( ( f 4 - f 2 ) / ( f 1 - f 3 ) ) \qquad ( 1 )$$

$$Thus :$$

$$\begin{matrix}fap {0}_{S} ( {x}^{′} , {y}^{′} ) = g 0 ( Id 01 ( {x}^{′} , {y}^{′} ) , Id 02 ( {x}^{′} , {y}^{′} ) , Id 03 ( {x}^{′} , {y}^{′} ) , Id 04 ( {x}^{′} , {y}^{′} ) ) \\ = arctan [ ( Id 04 ( {x}^{′} , {y}^{′} ) - Id 02 ( {x}^{′} , {y}^{′} ) ) / ( Id 01 ( {x}^{′} , {y}^{′} ) - Id 03 ( {x}^{′} , {y}^{′} ) ) ]\end{matrix} .$$

$$\begin{matrix}fap {0}_{Ref} ( {x}^{′} , {y}^{′} ) = g 0 ( Id {0}_{ref} 1 ( {x}^{′} , {y}^{′} ) , Id {0}_{ref} 2 ( {x}^{′} , {y}^{′} ) , Id {0}_{ref} 3 ( {x}^{′} , {y}^{′} ) , Id {0}_{ref} 4 ( {x}^{′} , {y}^{′} ) ) . \\ = arctan [ ( Id {0}_{ref} 4 ( {x}^{′} , {y}^{′} ) - Id {0}_{ref} 2 ( {x}^{′} , {y}^{′} ) ) / ( Id {0}_{ref} 1 ( {x}^{′} , {y}^{′} ) - Id {0}_{ref} 3 ( {x}^{′} , {y}^{′} ) ) ] .\end{matrix}$$

By way of illustration, the reference absolute phase function calculated with the 4 shifted sinusoidal patterns of FIG. 2 is also illustrated in FIG. 2. The reference absolute phase function calculated based on the 4 shifted sinusoidal patterns is illustrated in FIG. 2 (curve 20).

It may be seen that this function is a ramp over intervals of 2π and that it is therefore bijective over an interval of 2π: a value of x (or x′) within this interval corresponds to a single value of y (or y′): using 4 images with a different phase shift makes it possible to create a bijective phase function at each point.

The object absolute phase function fap0_{S} is also calculated in the same way based on the 4 detected distorted images Id0i(x′,y′).

This thus results in a mapping of the surface in terms of object absolute phase and in terms of reference absolute phase.

The paths of the various rays are reconstructed based on fap0_{S} and fap0_{Ref} via an algorithm. The bijective character of the reference and object absolute phase functions makes it possible to link a straight fringe of the reference images with the corresponding distorted fringe of the detected images, and thus to recover the shift dP (measured as a number of pixels in the sensor reference frame and then transformed into a distance) between these two fringes at a point P on the surface S. The bijective character is necessary to create a perfect mapping so as to correctly identify the fringes among one another.

Based on this shift, this displacement/shift dP determined in the reference frame of the sensor x′ and y′ is linked to angles seen by the optical imaging system coupled to the sensor. Conjugation and/or geometrical optics formulas are used for this. Once the direction from which each absolute phase originates is known, it is known that each ray strikes the surface S at a point, and is reflected by Snell-Descartes laws to a point on the screen. The slope of the surface as at the point P on the surface S is thus determined via Snell-Descartes laws.

The method is then reiterated in the direction Y (the pattern of the four displayed images is MSi(y)) so as to obtain the information regarding the slopes in both directions X and Y.

The information about the slopes along X and Y is used to deduce the curvature and/or altitude, as explained above.

The PSD method therefore processes in all at least 8 images, an object set of 4 images detected via a shift of the pattern along X and an object set of 4 images detected via a shift of the pattern along Y.

It has been demonstrated that 4 phases as described above per direction are necessary and sufficient to obtain the absolute phase function.

The conventional PSD method as described above exhibits drawbacks.

To make best use of the dynamic range of the camera, multiple fringes of the displayed pattern are used. This leads to phase jumps in the absolute phase function that correspond to phase discontinuities over multiple periods (visible on the ramp 20 of FIG. 2). To process these, it is necessary to “run the phase”, that is to say to implement complex two-dimensional algorithms that look for real phase jumps compared to calculation errors. In the case of multiple periods, the arctan function of g0 does not give the absolute phase, and it is necessary to run the phase to obtain it.

Implementing this “phase run” lengthens the analysis time and the complexity of the associated algorithms, and generates errors at discontinuities.

Since the focus of the camera is set on the surface to be characterized, and not on the virtual image of the displayed image, this leads to problems with the contrast (defocusing blur) of the detected fringes. To overcome this in conventional PSD, the imaging optics are closed (thereby increasing the size of the Airy spot) and the integration times of the detector are increased, thereby limiting analysis speed.

Conventionally, PSD systems have an oblique-incidence configuration. It is then difficult to be in focus on the entire surface. When seeking to analyze very flat surfaces (wafers for example), not being in focus on the entire surface is a limitation. Indeed, if depth of field decreases, being in an oblique-incidence configuration means that a decreasing portion of the surface to be measured is located in the zone of sharpness, and details on the edges are then lost. Furthermore, in an oblique-incidence configuration, the optical system has to be closed in order to gain depth of field. In addition to increasing the depth of field, closing the optical system reduces depth blur, and this makes it possible to regain contrast when there are multiple fringes to be distinguished on the screen. The trade-off is a longer exposure time, since the system is closed and less light is collected.

Finally, the pixels of the screens used to implement PSD do not emit an intensity that is transmitted linearly with respect to the initial information. Because of this non-linearity, the intensity emitted by the screen does not exhibit exactly a sinusoidal variation: it is not a true sine that is generated. At the time of calculation of the absolute phase, this leads to the occurrence of what is referred to as non-linearity periodic noise, which is not easy to remove. To attempt to attenuate it, it is necessary to:
carry out sophisticated calibration of the system, or
finely characterize the non-linearity of the screen so as to send a pre-distorted signal to the pixel so as to attempt to correct the non-linearity and emit a “true” sine.

Such an approach is described for example in the publication “Non-linearity response correction in phase shifting deflectometry” by Nguyen et al. (2018 Meas. Sci. Technol. 29,045012).

### SUMMARY OF THE INVENTION

One aim of the present invention is to remedy the abovementioned drawbacks by proposing an improved method and system for analyzing a reflective surface through deflectometry, which does not exhibit some of the abovementioned drawbacks and also exhibits better performance than a conventional phase-shifting deflectometry method.

The present invention relates to a method for analyzing a reflective surface through deflectometry, with a system comprising a display arranged such that luminous images displayed on the display are reflected from said reflective surface, and imaging optics configured to image said surface on a matrix detector, the method comprising the following steps:
A. successively displaying, on the display, n luminous images I [symbol] i indexed i, with n≥2, the n luminous images being obtained through n spatial shifts xi along a direction X of one and the same pattern, a luminous image I [symbol] i having a binarized luminous intensity that is obtained by dithering the pattern M(x−xi),
B. detecting, on the matrix detector, n images Idi, referred to as detected images, obtained by reflection of the n luminous images I [symbol] i from the reflective surface,
C. determining a function, referred to as object absolute phase function, based on the n detected images Idi, by applying a mathematical function g to said n detected images, the function g and the number of images n being determined such that the absolute phase function is bijective,
the function g also satisfying the relationship:

g(k·M)=g(M), with k being any real value,
D. comparing the object absolute phase function with what is referred to as a reference absolute phase function, determined by replacing the surface to be characterized with a plane mirror defining what is referred to as a reference plane, and deducing therefrom information about the shape of said surface.

According to one variant, the pattern is a sinusoid, n=4, and the four spatial shifts correspond to phase shifts respectively equal to 0, π/2, π, 3π/2.

According to one embodiment, the function g is defined by:

g=arctg[(fc4−fc2)/(fc1−fc3)], with fci corresponding to n=4 variables.

According to one embodiment, each luminous image displays only one period of the sinusoidal pattern.

According to another variant, the pattern is a Gaussian, n=2, a first spatial shift corresponding to a Gaussian centered on one edge of the luminous image I [symbol] 1, and a second spatial shift corresponding to a Gaussian centered on another edge of the image I [symbol] 2, and wherein the function g is defined by:

g=Ln(fc1)−Ln(fc2), with fci corresponding to n=2 variables.

According to one embodiment, the pattern is Fourier transform invariant.

According to one embodiment, the dithering is carried out using the Floyd-Steinberg dithering algorithm.

According to one embodiment, the imaging optics have an optical axis coincident with a normal to the reference plane, wherein said luminous images illuminate said surface perpendicularly to said reference plane, wherein the following are defined:
an optical center O of the imaging optics,
a positive distance Ddp between the display and the reference plane Pref and a positive distance Dpo between the reference plane and the optical center O,

and wherein step D comprises the following sub-steps:
determining, for points on the surface S, an angle β determined based on the shift between the object absolute phase function and the reference absolute phase function at said point on the surface,
determining said slope α with the following formula:

$$α = 0.5 \cdot [ β - \frac{π}{2} + a cos ( \frac{Dpo}{Ddp} cos ( β + \frac{π}{2} ) ) ]$$

According to another aspect, the invention relates to a system for analyzing a reflective surface through deflectometry, comprising:
a display arranged such that luminous images displayed on the display are reflected from said reflective surface, and configured to successively display n luminous images I [symbol] i indexed i, with n≥2, the n luminous images being obtained through n spatial shifts xi along a direction X of one and the same pattern M(x), a luminous image I [symbol] i(x,y) having a binarized luminous intensity that is obtained by dithering the pattern M(x−xi),
imaging optics and a matrix detector, the imaging optics being configured to image said surface on said matrix detector, the matrix detector being configured to detect n images Idi, referred to as detected images, obtained by reflection of the n luminous images I [symbol] i from the reflective surface,
a processing unit configured to:
determine a function, referred to as object absolute phase function, based on the n detected images Idi, by applying a mathematical function g to said n detected images, the function g and the number of images n being determined such that the absolute phase function is bijective, the function g furthermore satisfying the relationship:

g(k·M)=g(M), with k being any real value,
compare the object absolute phase function with what is referred to as a reference absolute phase function, determined by replacing the surface to be characterized with a plane mirror defining what is referred to as a reference plane, and deduce therefrom information about the shape of said surface.

According to one embodiment, the imaging optics have an optical axis arranged perpendicularly to said reference plane, and wherein the optical system furthermore comprises a beam splitter configured to send said luminous images onto said surface perpendicularly to said reference plane.

According to another aspect, the invention relates to a computer program comprising instructions that cause the system according to the invention to carry out the steps of the method according to the invention.

The following description presents several exemplary embodiments of the device of the invention: these examples do not limit the scope of the invention. These exemplary embodiments not only contain the features essential to the invention but also additional features associated with the embodiments in question.

### BRIEF DESCRIPTION OF THE DRAWINGS

The invention will be better understood and other features, aims and advantages thereof will become apparent from the following detailed description, which is provided with reference to the appended drawings, which are given by way of non-limiting examples and in which:

FIG. 1, already cited, illustrates a conventional assembly of a phase-shifting deflectometry device.

FIG. 2, already cited, illustrates, in A, the sinusoidal pattern MS(x) and, in B, the four shifted patterns MSi(x) and the associated absolute phase function.

FIG. 3 illustrates the method according to the invention.

FIG. 4 illustrates the system according to the invention.

FIG. 5 illustrates one example of an image that has been binarized by dithering a sinusoidal pattern displayed on the display in the method/system according to the invention.

FIG. 6 illustrates, in A, the intensity distribution of the displayed image in three successive planes as light propagates in space: I: on the display (d0=0); II: at a distance d1 from Disp for which the averaging is not yet sufficient; III: at a distance d2 far enough from the screen Disp for the averaging to be successful. B illustrates, for the three situations, one example of the variation in the intensity I of the image along the axis X.

FIG. 7 schematically shows one example of the MTF of the detected image: in situation I in A and in situation III in B.

FIG. 8 illustrates one embodiment of the invention in which each luminous image displays only one period of the sinusoidal pattern and the associated reference absolute phase function.

FIG. 9 illustrates one example of a measurement carried out with a system according to the invention displaying a single period of the binarized sinusoidal pattern for the measurement of a concave surface S. The concavity was deduced so as to reveal defects on the surface.

FIG. 10 illustrates a measurement of the same concave surface (deduced concavity) carried out with a conventional PSD system.

FIG. 11A illustrates the measurement of a 2-inch silicon wafer carried out with the system according to the invention.

FIG. 11B illustrates the measurement of this same wafer with a commercially available laser interferometer apparatus (Zygo).

FIG. 12 illustrates a second variant of the invention in which the pattern is a Gaussian and the associated reference absolute phase function. n=2, the image I [symbol] 1 is formed by the Gaussian function pattern M1(x) centered on one edge of the image, and the image I [symbol] 2 is formed by the Gaussian function pattern M2(x) centered on the opposite edge of the image.

FIG. 13 illustrates the shift dP corresponding to a slope α at a point C on the surface to be characterized.

FIG. 14 is an optical diagram illustrating various quantities useful for understanding the invention.

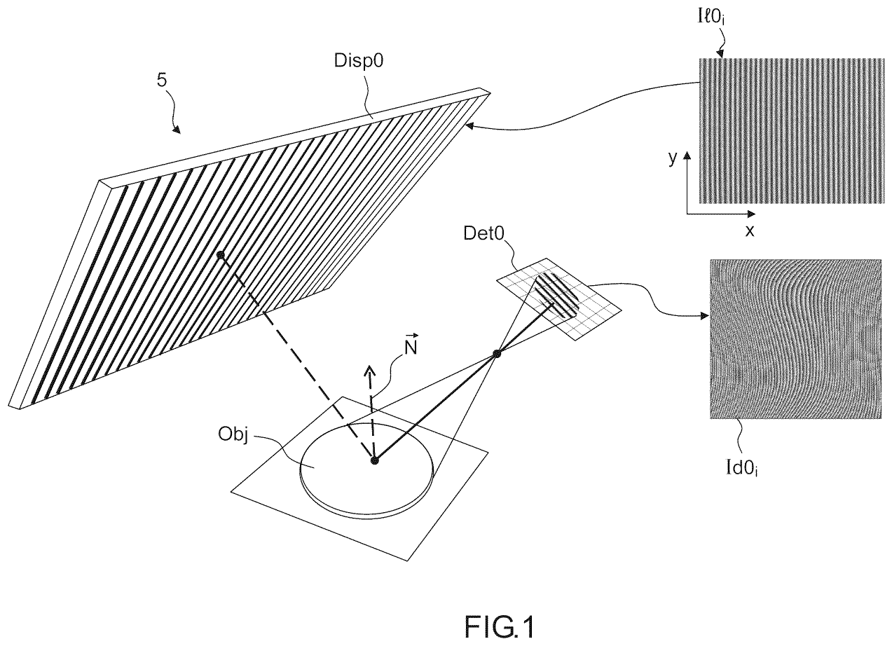

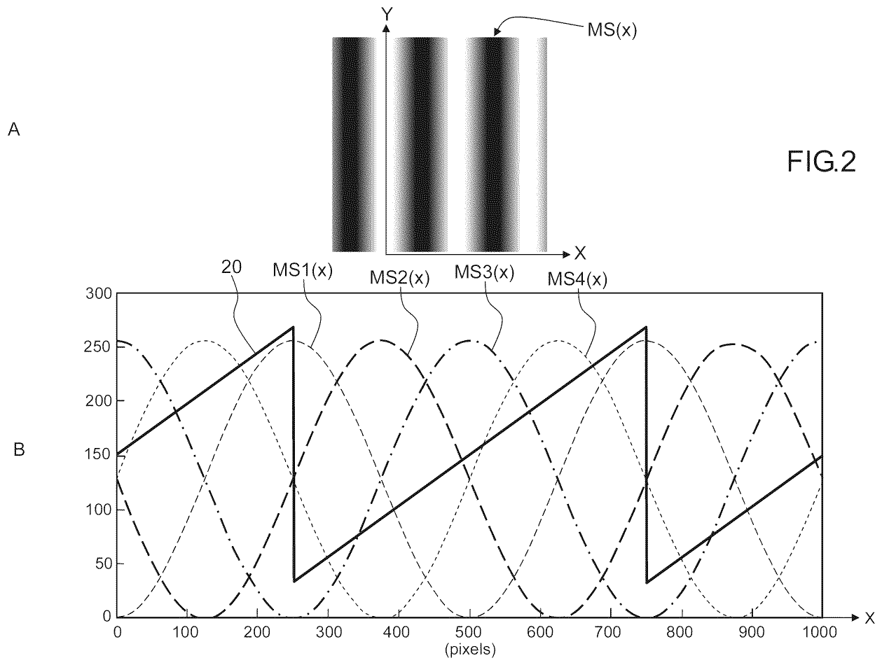

### DETAILED DESCRIPTION

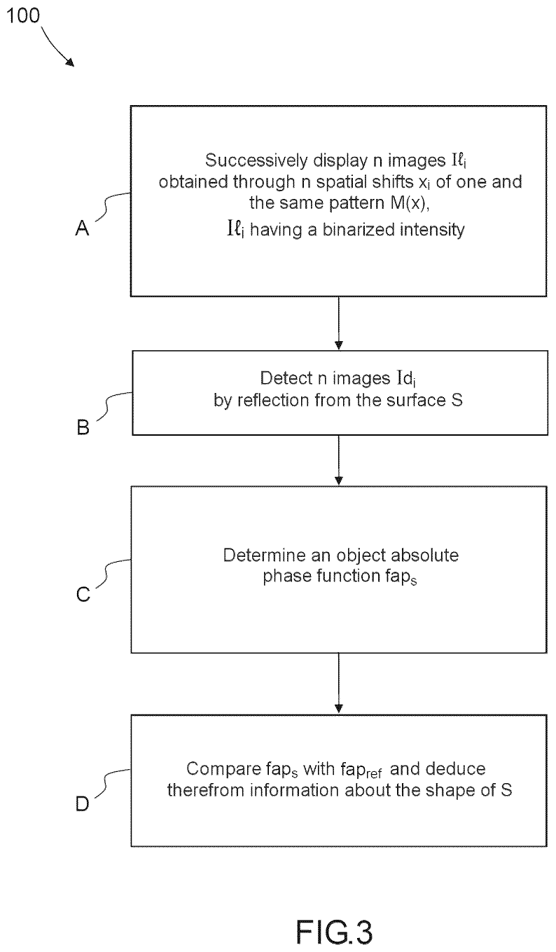

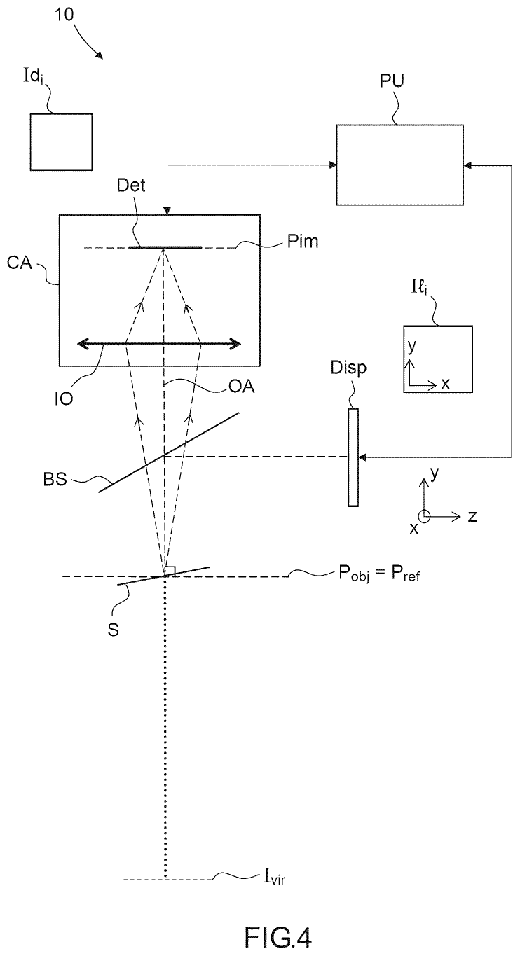

The subject of the present invention is a method 100 for analyzing a reflective surface S through deflectometry, illustrated in FIG. 3, which constitutes an improvement to the conventional PSD method as described above. According to another aspect, the invention also relates to a system 10, illustrated in FIG. 4, which implements the method 100. The system 10 comprises a display Disp arranged such that luminous images displayed on the display are reflected from the reflective surface S, and imaging optics IO configured to image the surface on a matrix detector Det. The imaging optics/detector assembly forms for example a camera CA.

The method according to the invention is a generalization of conventional PSD in the sense that it works not only with a sinusoidal pattern M(x) but also with other patterns, and makes it possible to solve certain problems inherent to PSD, thereby improving its performance.

The method comprises a first step A in which n luminous images I [symbol] i indexed i, with n≥2, are successively displayed on the display Disp, the n luminous images being obtained by n spatial shifts xi along a direction X of one and the same pattern M(x). X and Y are defined as the two directions of the reference frame of the image I [symbol] i(x,y).

Unlike a luminous image used in conventional PSD, the luminous images I [symbol] i exhibit a binarized luminous intensity that is obtained by dithering the pattern M(x−xi), also called Mi(x). Following numerous experiments and simulations, the inventors established that such dithering was surprisingly compatible with a characterization of the surface through phase-shifting deflectometry, and very markedly improved its performance while at the same time allowing the use of patterns other than a sinusoid (see below). The expression “binarized image that is obtained by dithering” is understood to mean the transformation of a grayscale image, the grayscale levels of which are typically coded between 1 and 255 (8 bits), into an image comprising only points having a non-zero intensity, preferably a maximum intensity (coded 1 or 255) and points having zero intensity (coded 0). The dithering thus generates an image the spatial density of points of which varies in accordance with the pattern M(x) along the direction X. There are numerous dithering algorithms, and the inventors tested several of them that give good results. Mention may be made, without limitation, of:
the algorithm consisting in generating a random image in which each pixel has a probability in the form (sin(x)+1)/2 of being at 1 (or 0),
the Floyd-Steinberg dithering algorithm.

Other dithering algorithms are easily accessible on the Internet.

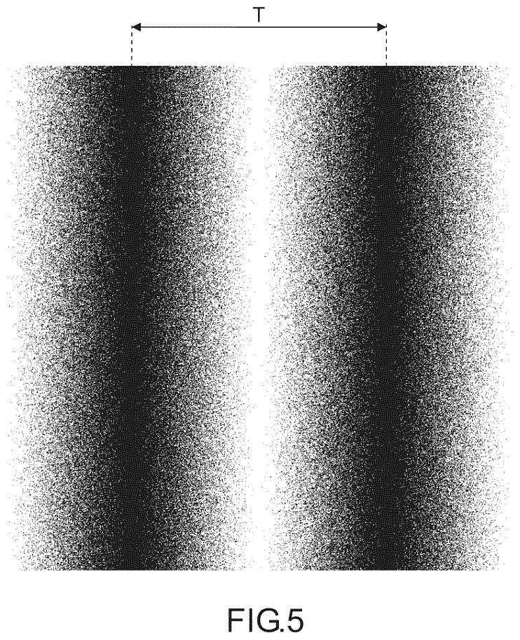

FIG. 5 illustrates one example of an image that has been binarized by dithering a sinusoidal pattern of period T.

In a second step B, n images Idi(x′,y′), referred to as detected images and obtained by reflection of the n luminous images I [symbol] i from the reflective surface S, are detected on the matrix detector Det. The coordinates (x′, y′) of the detected image are related to the coordinates (x, y) of the displayed image by a magnification factor. The directions of the reference frame of the detected image are still referred to as (X, Y).

This step B is identical to what is conventionally practiced in PSD, except that, conventionally, it is always the case that n=4 and M(x) is a sinusoid.

In a step C, a function, referred to as object absolute phase function fap_{S}, is determined based on the n detected images Idi, by applying a mathematical function g to the n detected images, the function g and the number of images n being determined such that the absolute phase function is bijective, that is to say:

$$y ’ = {fap}_{S} ( x ’ ) where y ’ is unique for each value of x ’ \qquad ( 2 )$$

When the pattern is sinusoidal and n=4, the mathematical function g is equal to g0 given by formula (1).

The function g also satisfies the relationship:

$$g ( k \cdot M ) = g ( M ) \qquad ( 3 )$$

with k being any real value.

This condition (3) stems from the fact that the operator g has to be insensitive to the reflectivity of the surface, the intensity reflected by the surface S and detected by the detector Det being proportional to this reflectivity. The function g applied to the images therefore must not retain this reflectivity, which has to cancel itself out. One example is canceling out reflectivity by way of a ratio between images (see formula 1). When a pattern other than a sinusoid is used, the function g is different from formula (1).

In a step D, the object absolute phase function fap_{S} is compared with what is referred to as a reference absolute phase function fap_{Mref}, determined by replacing the surface S to be characterized with a plane mirror Mref defining what is referred to as a reference plane Pref illustrated in FIG. 4, and information about the shape of said surface is deduced therefrom, in the same spirit as what is carried out in conventional PSD. The reference absolute phase function is obtained based on the 4 detected reference images Idrefi.

It should be noted that the imaging optics IO are configured to image the surface S and not the virtual image of the display (in the same way as for conventional PSD). The image displayed on Disp is therefore not in focus on the detector Det; it is blurred.

Like in conventional PSD, steps A to D are reiterated along the axis Y so as to obtain slope information along the direction Y.

When the geometrical parameters of the system are not changed, it is possible to use one and the same reference absolute phase function for multiple measurements of various surfaces. If the parameters, for example the display-to-surface distance, and/or the surface-to-imaging optics distance, and/or the focal length of the imaging optics, are changed, it is necessary to detect the 4 images Id_{ref}i (with the mirror Mref in place of S) and to determine the reference absolute phase function based on these 4 images in the new configuration.

The system 10 according to the invention illustrated in FIG. 4 therefore comprises:
a display Disp arranged such that luminous images displayed on the display are reflected from the reflective surface S, and configured to successively display the n binarized luminous images I [symbol] i,
imaging optics IO and a matrix detector Det, the imaging optics being configured to image the surface S on the detector Det, the matrix detector being configured to detect the n images Idi, obtained by reflection of the n luminous images I [symbol] i from the reflective surface S,
a processing unit (PU) configured to implement steps C of determining the object absolute phase and D of comparing the object and reference absolute phase functions and of determining information about the shape of S.

Without limitation, FIG. 4 illustrates a normal-incidence configuration that is preferred for implementing the method according to the invention. The expression “normal incidence” is understood to mean a configuration in which the optical axis OA of the imaging optics IO is perpendicular to the reference plane Pref and in which the system comprises a beam splitter BS configured to send the luminous images onto the surface S perpendicularly to the reference plane Pref. This normal-incidence configuration is rarely used in conventional PSD. Since it is sought to determine very small slope angles α, the entire surface S is in focus on the detector.

The inventors have established that the binarization of the displayed image I [symbol] , combined with the defocusing of the image of I [symbol] produced by IO, makes it possible to obtain, on the surface S, light coming from the display corresponding to “true” sine, rather than a degraded sine, as is the case in conventional PSD.

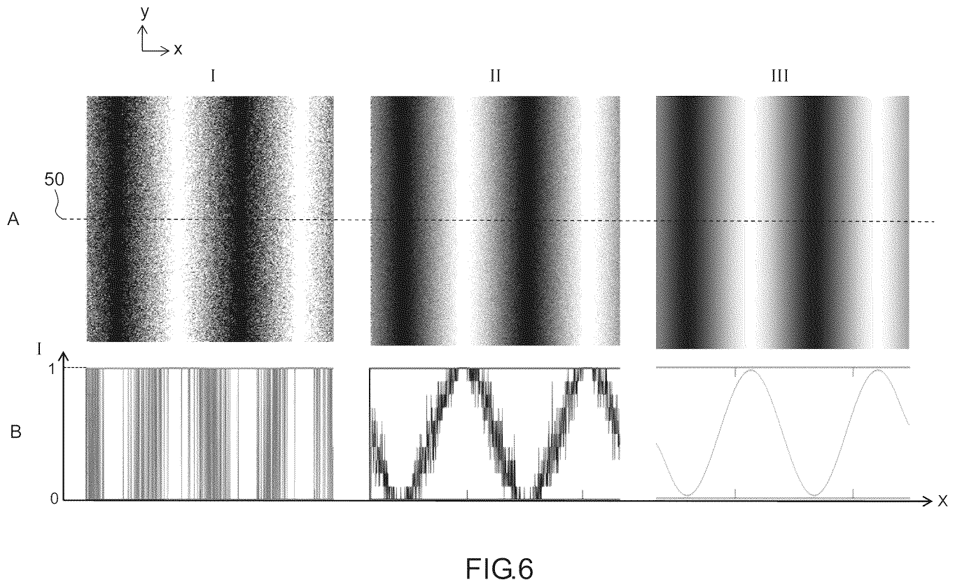

This is due to the fact that the binarized image is averaged as it propagates in space and, if the display is arranged at a sufficient distance from the surface S, gives a sinusoidal function close to a perfect sine. FIG. 6 illustrates, in A, the intensity distribution of the displayed image I [symbol] in three successive planes as light propagates in space: I: on the display (d0=0); II: at a distance d1 from Disp for which the averaging is not yet sufficient; III: at a distance d2 far enough from the screen Disp for the averaging to be successful. B illustrates, for the three situations, one example of the variation in the intensity I of the image along the axis X (which oscillates between 1 (255) and 0) for a cross section along an axis 50, showing the averaging over the course of the propagation. The Gaussian blur of the binarized image corresponds to the free-space propagation of light.

In other words, the image in I corresponds to what the detector detects when the camera is in focus on the virtual image Ivir (the image in I here is a real image of the virtual image of the screen Ivir created by the surface S), and the image in III corresponds to what the detector detects when the camera is in focus on the surface S, that is to say when the measurement is carried out.

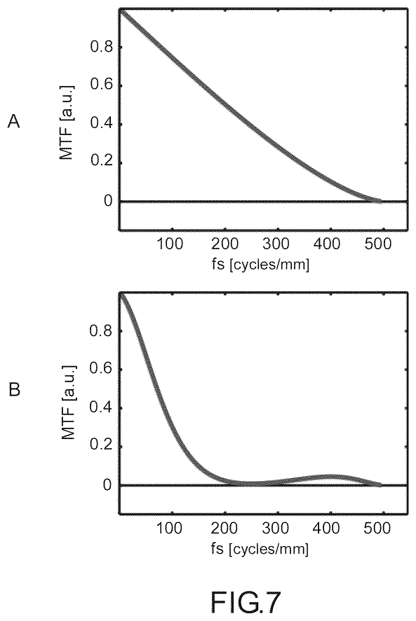

FIG. 7 schematically shows one example of the MTF (modulation transfer function, function of spatial frequency fs in cycle/mm) of the image detected by Det: in situation I (focus on the virtual image of the display) in A, for which the image exhibits high spatial frequencies, and in situation III (focus on the surface S) in B, for which the high spatial frequencies have been eliminated: the high spatial frequencies present in the binarized image are eliminated during propagation and a “true” sine is created on the surface S.

The binarization of the displayed image thus makes it possible to considerably reduce or even remove non-linearity periodic phase noise present in conventional PSD, which no longer exists here since the displayed image is binarized and no longer analog. This is true because LCD screens are homogeneous for a given intensity, but are non-linear for variations in intensity. This noise removal avoids complex calibrations of the system and greatly simplifies the implementation thereof.

For the measurement, the setting of the display-to-surface distance must be sufficient for the propagation averaging to be effective, that is to say for the filtering of the high frequencies of the binarized image to take place. This setting is carried out for example by visually checking that the detected pattern exhibits a variation considered to be satisfactory or by characterizing the curve of the variation in the detected intensity along an axis parallel to X (see curves in FIG. 6, part B for II and IIII).

To set the aperture of the system, the aperture is made as large as possible so as to reduce the depth of field and maximize the averaging (but not too much if the optics that are used are less efficient at maximum apertures).

In summary, the adjustment variables to correctly average dither are:
take a screen with a greater pixel density,
open the optical system,
move the screen away,
possibly bring the objective closer to the target,
optionally paste a frost on the screen in order to exacerbate the averaging in addition to the propagation.

The system 10 according to the invention, with a normal-incidence configuration, makes it possible to bring the imaging optics IO closer to the surface to be characterized (see below). This makes it possible to increase the relative value of the abovementioned deviation between the straight fringe and the curved fringe, related directly to the value of the slope α that is sought, and therefore to measure smaller values of α than with conventional PSD. The normal-incidence configuration also allows focusing on the entire surface, this being very useful for characterizing very flat surfaces, that is to say with very small slopes α.

At a sufficient distance from the display, the propagation of the emitted wave is similar to a Fourier transform. Preferably, a Fourier transform invariant pattern M(x) is chosen so as to obtain, on the surface S, a pattern of the same nature as that displayed on Disp.

As explained above, according to a first variant, the pattern M(x) is a (binarized) sinusoidal pattern. In this case, n=4 and the four spatial shifts xi correspond to phase shifts respectively equal to 0, π/2, π, 3π/2.

Preferably, the mathematical function g applied to the 4 detected images Idi (object) and to the 4 reference images Id_{ref}i, corresponding to 4 variables referred to as fci, is:

$$g = arc tg [ ( fc 4 - fc 2 ) / ( fc 1 - fc 3 ) ] .$$

with fci=Idi (for the calculation of fap_{S}) and fci=Id_{ref}i (for the calculation of fap_{ref})

This formula is identical to formula (1) used for a conventional PSD method.

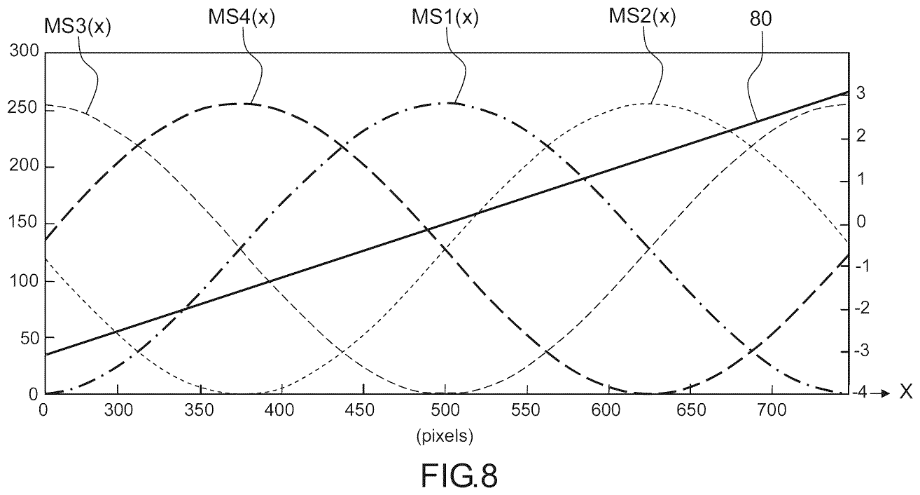

According to one embodiment of the method 100 and of the system 10, according to the invention, each luminous image displays only one period of the pattern, as illustrated in FIG. 8 for the sinusoidal pattern: the spatial frequency of the sine of the pattern is reduced. Indeed, with the invention, the objective is opened, thereby optimizing the spatial frequencies close to the sample to be characterized, and reducing the contrast of the fringes displayed on the screen. To recover a good contrast on the display, it is therefore necessary to lower the spatial frequency of the fringes that are displayed.

The object absolute phase function calculated with formula (1) is equal to the curve 80, which no longer exhibits discontinuities (phase jumps).

Using only one period makes it possible not to have to “run” the phase (see the prior art), thereby making the algorithm for recovering dy and the slopes much less complex and faster. Furthermore, with a single fringe, there is more signal because there is no loss of contrast on the detected fringes. Indeed, if using multiple fringes, that is to say a higher spatial frequency on the display, as stated above, the contrast of the high spatial frequencies decreases. A decrease in contrast implies a loss in terms of the dynamic range of the camera. With a single fringe, looking at the MTF, it may be seen that low frequencies are transmitted far better than high frequencies, regardless of the focus. A good contrast is therefore maintained, and there is more signal because max-min tends toward 1: the dynamic range of the camera is then exploited as best as possible.

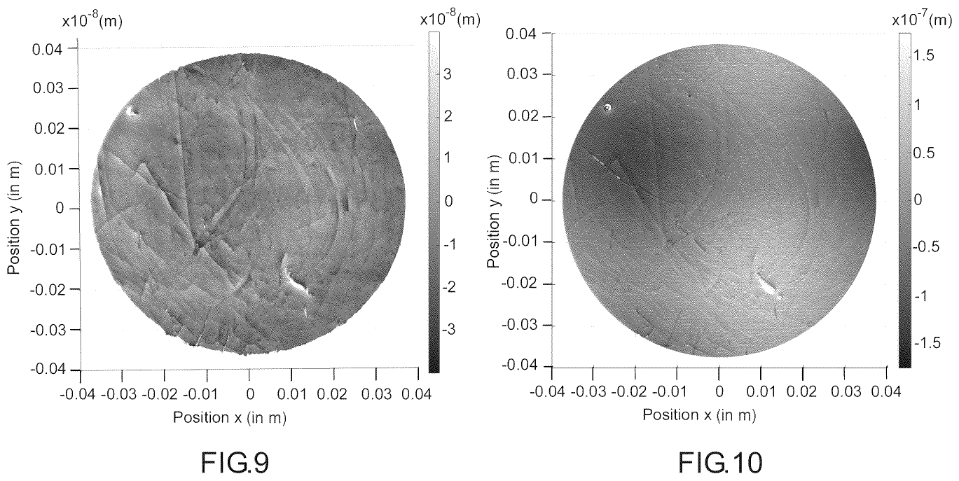

FIG. 9 illustrates one example of a measurement carried out with a system according to the invention displaying a single period of the binarized sinusoidal pattern for the measurement of a concave surface S. The concavity was deduced so as to reveal defects on the surface. It may be seen on the scale on the right that measurement sensitivity regarding residual defects on the surface is approximately +/−30 nm. The defects on the surface may be seen clearly.

The system has the following features:
Imaging optics-to-sample optical center distance O: 47 cm
Screen-to-Pref distance: 71 cm
Focal length of the imaging optics: 50 mm
Resolution of the detector 4512×4512 pixels, pixel size 2.74 μm
Aperture of the imaging device: N=2
Screen used: conventional LCD computer screen

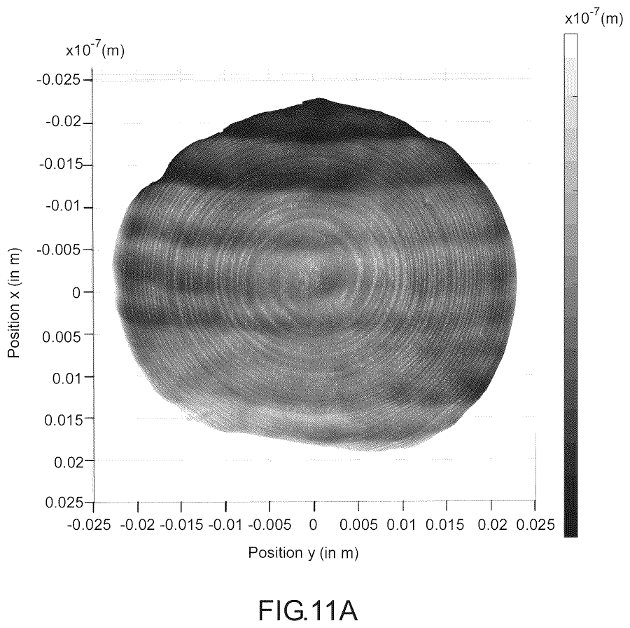

By way of comparison, FIG. 10 illustrates a measurement of the same concave surface (deduced concavity) carried out with a conventional PSD system displaying a period of an analog pattern, without pre-correction of the non-linearity of the display and with the same system as described above. It may be seen on the scale on the right that measurement sensitivity regarding residual defects on the surface is approximately +/−150 nm. This is due to phase noise, which adds a parasitic modulation. This modulation corresponds to the dark and light zones in the image. Because of this parasitic signal, measurement accuracy is poorer and defects are less visible.

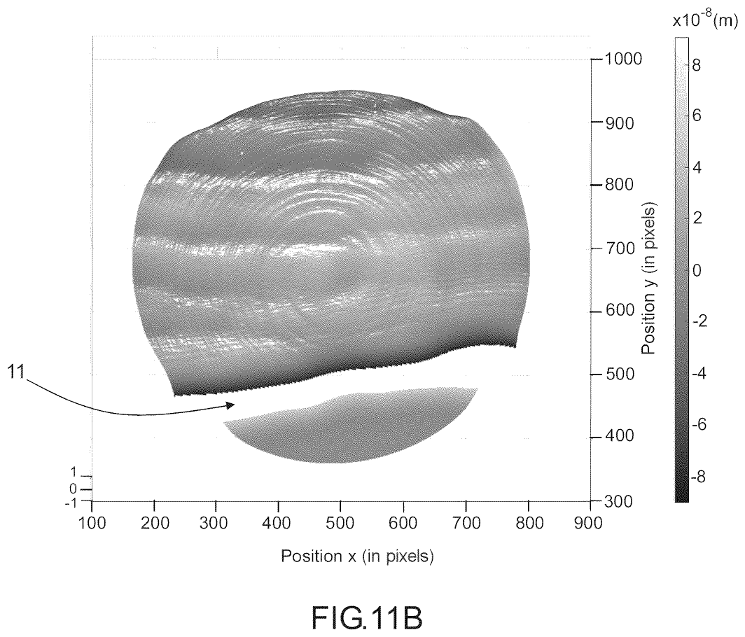

FIG. 11A illustrates a measurement carried out with the system according to the invention of a 2-inch silicon wafer surface (deduced overall curvature). The polishing grooves, of nanometric thickness, are visible and the image of the surface is complete. The measured thickness variation amplitude is +/−100 nm, that is to say 200 nm (see scale on the right).

FIG. 11B illustrates a measurement of this same wafer (deduced overall curvature) carried out with a commercially available Zygo laser interferometer apparatus. It is possible to see a zone 11 without measurements, corresponding to a measurement artefact. Indeed, the object is too curved for the measurement to be possible with the Zygo, this having a measurement dynamic range of +/−80 nm, that is to say at most 160 nm. Zones corresponding to a thickness variation that exceeds this are not processed and appear white.

The system according to the invention thus exhibits better performance than the Zygo for this measurement: the dynamic range is much greater and details at high spatial frequencies (grooves) are better defined.

The inventors have shown that the method according to the invention is compatible with patterns other than the sinusoidal pattern.

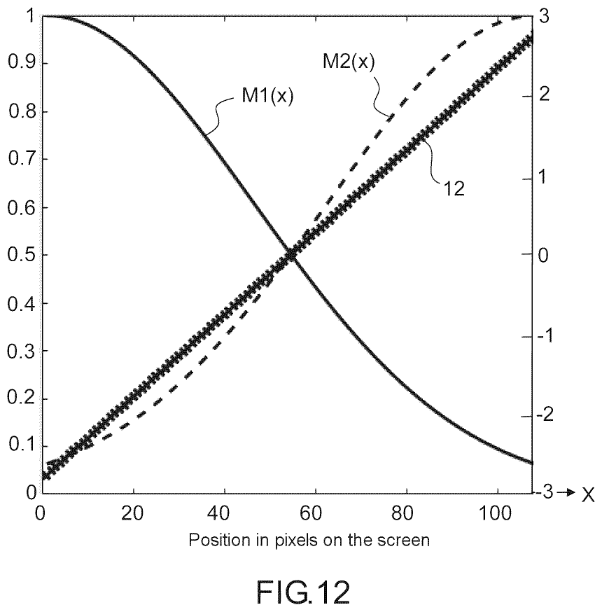

According to a second variant, the pattern is a Gaussian and n=2. The image I [symbol] 1 is formed by the Gaussian function pattern M1(x) centered on one edge of the image, and the image I [symbol] 2 is formed by the Gaussian function pattern M2(x) centered on the opposite edge of the image, as illustrated in FIG. 12. The maximum of the Gaussian is coded at 1. The two Gaussians have the same parameters (amplitude, width).

The inventors have shown that a function g defined by formula (4) below is bijective and satisfies condition (3):

$$g = Ln ( fc 1 ) - Ln ( fc 2 ) \qquad ( 4 )$$

The reference absolute phase function calculated with the function g of formula (4) is also illustrated in FIG. 12 (curve 12). It does not exhibit any discontinuity. It should be noted that the function g of formula (4) indeed satisfies the condition g(kM)=g(M), and that a Gaussian function is Fourier transform invariant.

It should be ensured that the Gaussian maximum does not saturate the camera and that its Gaussian minimum is not below the noise level of the camera.

The advantage of this Gaussian pattern is that 2×2 images are necessary and sufficient to implement the method according to the invention, compared to 2×4 images with the use of a sinusoidal pattern. This allows faster acquisition, processing, and therefore measurement.

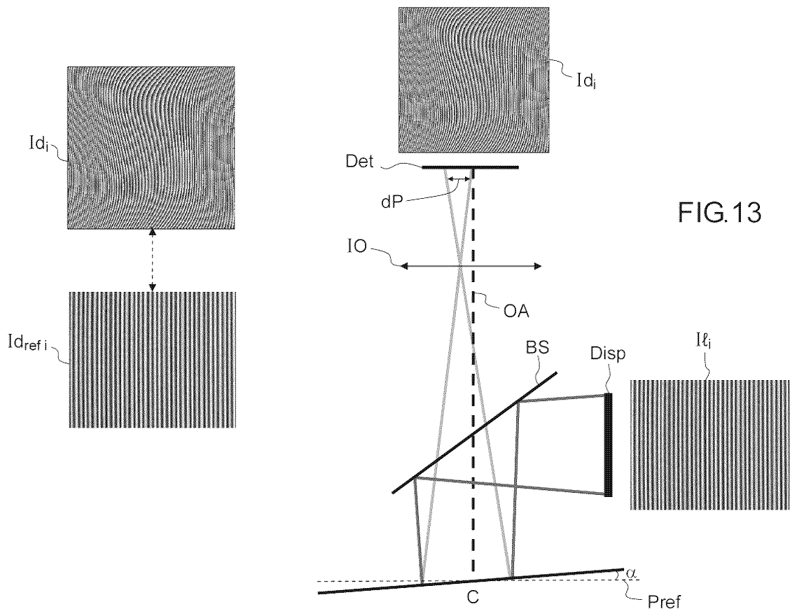

The system according to the invention is highly flexible because it is possible to modify the geometrical parameters as a function of the desired accuracy, that is to say the order of magnitude of the angle α of the local slope on the surface S. FIG. 13 illustrates the shift dP corresponding to an angle α at a point C of S. This shift dP, measured in the reference frame (x′, y′) of the detector, is the distance between the absolute phase of a fringe when α=0 (reference) and the absolute phase of the same fringe when the surface C has an angle α locally. This shift is measured separately along x′ (pattern displayed along x) and along y′ (pattern displayed along y).

The optical center O of the imaging optics is defined, and β is the name given to the angle corresponding to this measured shift dP with respect to the center O (O is the vertex of β). The angle β is thus determined based on the shift dP between the object absolute phase function and the reference absolute phase function at the point C on the surface.

The inventors have determined a relationship between α and β as a function of the parameters of the system for the preferred normal-incidence configuration. This relationship involves only two quantities: a positive distance Ddp between the display and the reference plane Pref, and a positive distance Dpo between the reference plane Pref and the optical center O.

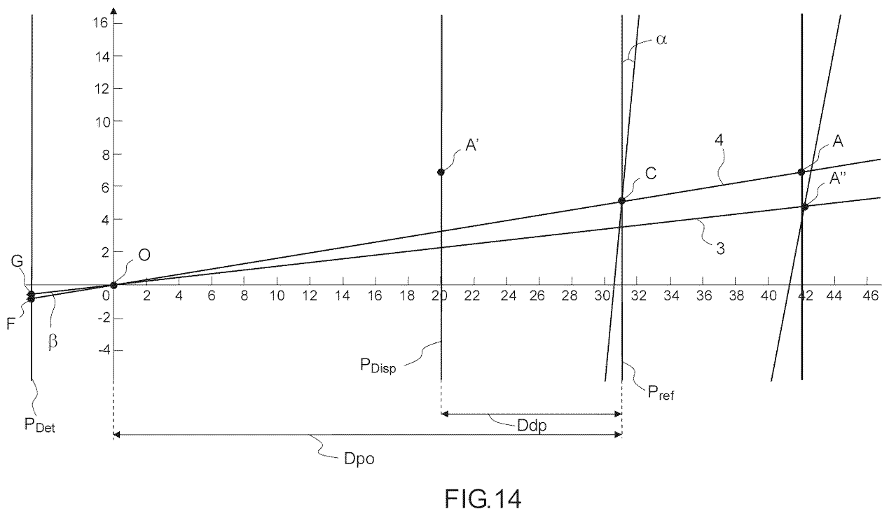

The diagram of FIG. 14 illustrates these various quantities in an optical diagram for a numerical example with Ddp=11 cm and Dpo=31 cm. P_{Disp} is the plane in which the display Disp is arranged and P_{Det} is the plane in which the detector Det is arranged.

The point A′ is a point on the display.

The point A is the virtual image of A′ when the reference mirror Mref is arranged in Pref (perpendicular to OA). A ray coming from A′ is reflected at the point C (ray 3) and is focused at the point F in the plane P_{Det}.

The point A″ is the virtual image of A′ when it is the surface S with, at C, a local slope α that reflects the ray coming from A′. This ray reflected by C (ray 4) is focused at the point G in the plane P_{Det}. This applies for small angles. The ray is reflected by a point very close to the point C. For small angles, and to establish the formula below, it has been considered that this point is C.

The distance FG corresponds to the shift dP.

The angle β is thus the angle formed between the points F, O (optical center to vertex) and G, where F is the position of the absolute phase on the detector of a fringe on the screen (A′) after reflection from the reference and G is the position of the absolute phase on the detector of the same fringe after reflection from the sample having an angle α.

The relationship established by the inventors is:

$$α = 0.5 \cdot [ β - \frac{π}{2} + a cos ( \frac{Dpo}{Ddp} cos ( β + \frac{π}{2} ) ) ] \qquad ( 5 )$$

This formula is of course to be applied independently along X and Y.

The absolute phase of a reference fringe drops at F, and the absolute phase of the same fringe after reflection from the sample drops at G. When the phase varies in the direction X, then F in the reference frame (x′, y′) is at x′_{F} and G is at x′_{G}, and:

dx′=x′_{G}−x′_{F}, distance between F and G

For the simplified case of a thin lens:

βx=arctan(dx′/f) f focal length of the imaging optics

For a more complex objective, the position of the main planes is taken into account.

αx is then determined with formula (5).

Thus, according to one embodiment of the method 100 according to the invention in step D, the angle β is first determined, followed by the angle α, using formula (5).

It may be seen from this formula (5) that the relationship between α and β may be adjusted as a function of the chosen values of the distances Dpo and Ddp. This is an important advantage of the system/method according to the invention.

Conventionally, in a conventional oblique-incidence PSD system, these two distances are equal, and therefore α=β. See for example the publication “Review of phase measuring deflectometry” by Huang et al (Optics and Lasers Engineering, volume 107, August 2018, pages 247-257).

When it is desired to measure very small slopes α, it is sought to increase the proportionality factor between α and β. Studying formula (5) shows that increasing this proportionality factor is tantamount to decreasing/minimizing the coefficient Dpo/Ddp. At a constant focal length, this is tantamount to bringing the camera closer (decreasing Dpo) and moving the screen away (increasing Ddp).

A measurement of very small slopes α is also obtained by increasing the focal length of the imaging optics.

The document “Phase measuring deflectometry for obtaining 3D shape of specular surface: a review of the state of the art” by Zhang et al (Optical Engineering, vol 60(2), 020903-1; 2021) describes a conventional PSD method with these two different distances Dpo and Ddp. However, it is then necessary to carry out a highly complex calibration in the camera space in order ultimately to obtain the correct values (see § 4 Error source analysis).

1. A method for analyzing a reflective surface (S) through deflectometry, with a system comprising a display (Disp) arranged such that luminous images displayed on the display are reflected from said reflective surface (S), and imaging optics (IO) configured to image said surface on a matrix detector (Det),
the method comprising the following steps:
A successively displaying, on the display (Disp), n luminous images I [symbol] i indexed i, with n≥2, the n luminous images being obtained through n spatial shifts xi along a direction X of one and the same pattern M(x), a luminous image I [symbol] i having a binarized luminous intensity that is obtained by dithering the pattern M(x−xi),
B detecting, on the matrix detector (Det), n images Idi, referred to as detected images, obtained by reflection of the n luminous images I [symbol] i from the reflective surface (S),
C determining a function, referred to as object absolute phase function (fap_{S}), based on the n detected images Idi, by applying a mathematical function g to said n detected images, the function g and the number of images n being determined such that the absolute phase function is bijective,
the function g also satisfying the relationship:
g(k·M)=g(M), with k being any real value,
D comparing the object absolute phase function (fap_{S}) with what is referred to as a reference absolute phase function (fap_{Mref}), determined by replacing the surface (S) to be characterized with a plane mirror (Mref) defining what is referred to as a reference plane (Pref), and deducing therefrom information about the shape of said surface.

2. The method as claimed in claim 1, wherein the pattern is a sinusoid, n=4, the four spatial shifts corresponding to phase shifts respectively equal to 0, π/2, π, 3π/2.

3. The method as claimed in claim 2, wherein the function g is defined by:
g=arctg[(fc4−fc2)/(fc1−fc3)], with fci corresponding to n=4 variables,
fci corresponding to the images detected with said reflective surface for calculating the object absolute phase function, and to the images detected with said reference mirror for calculating the reference absolute phase function.

4. The method as claimed in claim 2, wherein each luminous image displays only one period of the sinusoidal pattern.

5. The method as claimed in claim 1, wherein the pattern is a Gaussian, n=2, a first spatial shift corresponding to a Gaussian centered on one edge of the luminous image I [symbol] 1, and a second spatial shift corresponding to a Gaussian centered on another edge of the image I [symbol] 2, and wherein the function g is defined by:
g=Ln(fc1)−Ln(fc2), with fci corresponding to n=2 variables,
fci corresponding to the images detected with said reflective surface for calculating the object absolute phase function, and to the images detected with said reference mirror for calculating the reference absolute phase function.

6. The method as claimed in claim 1, wherein the pattern is Fourier transform invariant.

7. The method as claimed in claim 1, wherein the dithering is carried out using the Floyd-Steinberg dithering algorithm.

8. The method as claimed in claim 1, wherein the imaging optics have an optical axis coincident with a normal to the reference plane, wherein said luminous images illuminate said surface perpendicularly to said reference plane, wherein the following are defined:
an optical center O of the imaging optics,
a positive distance Ddp between the display and the reference plane Pref and a positive distance Dpo between the reference plane and the optical center O, and wherein step D comprises the following sub-steps:
determining, for points on the surface S, an angle β determined based on the shift between the object absolute phase function and the reference absolute phase function at said point on the surface,
determining said slope α with the following formula:
$$α = 0.5 \cdot [ β - \frac{π}{2} + a cos ( \frac{Dpo}{Ddp} cos ( β + \frac{π}{2} ) ) ] .$$

9. A system for analyzing a reflective surface (S) through deflectometry, comprising:
a display (Disp) arranged such that luminous images displayed on the display are reflected from said reflective surface (S), and configured to successively display n luminous images I [symbol] i indexed i, with n≥2, the n luminous images being obtained through n spatial shifts xi along a direction X of one and the same pattern M(x), a luminous image I [symbol] i(x,y) having a binarized luminous intensity that is obtained by dithering the pattern M(x−xi),
imaging optics (IO) and a matrix detector (Det), the imaging optics being configured to image said surface (S) on said matrix detector, the matrix detector being configured to detect n images Idi, referred to as detected images, obtained by reflection of the n luminous images I [symbol] i from the reflective surface (S),
a processing unit (PU) configured to:
determine a function, referred to as object absolute phase function (fap_{S}), based on the n detected images Idi, by applying a mathematical function g to said n detected images, the function g and the number of images n being determined such that the absolute phase function is bijective, the function g furthermore satisfying the relationship: g(k·M)=g(M), with k being any real value,
compare the object absolute phase function (fap_{S}) with what is referred to as a reference absolute phase function (fap_{Mref}), determined by replacing the surface (S) to be characterized with a plane mirror (Mref) defining what is referred to as a reference plane (Pref), and deduce therefrom information about the shape of said surface.

10. The system as claimed in claim 9, wherein the imaging optics have an optical axis (OA) arranged perpendicularly to said reference plane, and wherein the optical system furthermore comprises a beam splitter (BS) configured to send said luminous images onto said surface perpendicularly to said reference plane.

11. A non-transitory computer-readable storage medium having stored thereon a computer program comprising instructions that when implemented on a computer, cause a system for analyzing a reflective surface through deflectometry to carry out the steps of the method as claimed in claim 1.
